(19) United States
(12) Patent Application Publication
(10) Pub. No.: US 2010/0142773 A1
(43) Pub. Date: Jun. 10, 2010

(54) METHOD AND SYSTEM FOR ACCURATELY MEASURING VERY SMALL VOLUME OF BLOOD

(76) Inventors: Eun Jong Cha, Cheongju-City (KR); Mi Sook Park, Cheongju-City (KR); Kyung Ah Kim, Cheongju-City (KR)

Correspondence Address: GREER, BURNS & CRAIN, 300 S WACKER DR, 25TH FLOOR, CHICAGO, IL, 60606, US

(21) Appl. No.: 12/331,865

(22) Filed: Dec. 10, 2008

(51) Int. Cl. G06T 7/00

(52) U.S. Cl. 382/128

(57) ABSTRACT

A method and system for accurately measuring a very small volume of blood is used for accurate evaluation of an amount (volume) of blood collected by a lancing device, evaluation of a scientific very small amount of blood, and so on. The method includes the steps of collecting the very small volume of blood, absorbing the very small volume of collected blood into an absorption medium, drying the absorption medium, scanning the dried absorption medium using an image scanner connected to a computer to obtain a digital image, and calculating the very small volume of blood from the digital image using an analysis program.

### BACKGROUND OF THE INVENTION

1. Field of the Invention

The present invention relates generally to a method and system for measuring a volume of blood, and more particularly to a method and system for accurately measuring a very small volume of blood, which is used for accurate evaluation of an amount (volume) of blood collected by a lancing device, evaluation of a scientific very small amount of blood, and so on.

2. Description of the Prior Art

In general, any diabetic patient must daily measure a value of glucose (sugar) in the capillary blood by performing a self blood glucose test, thereby adjusting his/her blood glucose value to within a proper range. However, all blood glucose meters for measuring the glucose value from the capillary blood cannot make the blood glucose test only with a predetermined volume of blood.

As mentioned above, in order to collect the predetermined volume of blood, any finger of a human body is typically used. The ordinary blood glucose test that collects the capillary blood from the finger is based on the fact that the capillary blood vessels are sufficiently distributed on the finger. In this case, since the capillary vessels are sufficient, a sufficient volume of blood can be collected. Thus, the blood glucose test never meets with failure because of shortage of the volume of blood. However, since many pain cells are also distributed on the finger, the blood collection is accompanied by considerable pain. As such, the blood glucose test is very painful to the diabetic patients who must collect the blood almost every day.

For this reason, there are developed methods of collecting the capillary blood from an alternative site instead of the finger in order to minimize the pain when the blood is collected. Since the pain cells are very sparsely distributed at the alternative site such as the arm of the human body, particularly the forearm, the diabetic patients hardly feel pain even if the skin is punctured by a lancet. In this respect, the method of collecting the blood from the forearm is used. However, since the capillary vessels are also sparsely distributed at the alternative site, i.e. the arm, use is made of a technique that draws the blood using vacuum in order to collect a very small amount of blood up to a desired maximum amount (U.S. Pat. No. 6,152,942, and WO2005/030053 A1).

However, although the blood is drawn from the alternative site by applying as much vacuum pressure as possible within a range where the patient feels pain, a very small volume of blood (several μL or less) is often collected. According to circumstances, the blood glucose test can only result in failure.

Thus, it is essential to accurately measure the volume of blood collected from various human body sites or a lancing device for a successful and efficient blood glucose test. Since the blood collected from the alternative site is nothing but a very small amount, there a need is raised to precisely measure the volume of blood for the purpose of performance evaluation and quality control of the lancing device used for collecting the blood.

Further, in the typical method of measuring the volume of blood, since the blood has somewhat higher specific gravity and viscosity than water, but shows the same physical properties as ordinary liquid, its volume is measured after it is contained in a container such as a beaker marked on the side with lines indicating the volume contained. This method can be used only to measure a considerably large amount of blood having at least several mL (thousands of μL), because there is a limitation in reducing a size of the container.

Besides, as the method of measuring a smaller volume of blood, a capillary suction principle can be used, and particularly a characteristic that water tends to adsorb on the surface of glass surface is used. As in FIG. 1, when a small amount of water 10, i.e. a drop of water, comes into contact with the tip of a glass tube 20 having a small diameter, the water 10 adsorbs on an inner surface of the glass tube 20, and then is sucked Into the glass tube 20. At this time, since the inner diameter of the glass tube 20 is constant, after the water 10 is completely sucked in, a length of the collected water (L: suction length) is measured. Thereby, the volume of water can be calculated.

For example, when the glass tube 20 has a diameter of D, the cross section area A thereof is as follows: A=π(D/2)². Thus, the volume V of water is the product of cross section area A and suction length L, and is given as the following expression.

$$V = \frac{π {D}^{2} L}{4}$$

Solving it with respect to L, the following expression can be obtained.

$$L = \frac{4}{π {D}^{2}} V$$

Thus, as the diameter D of the glass tube 20 becomes small, i.e. as the glass tube 20 becomes thin, the capillary suction occurs well. As such, the diameter of the glass tube 20 should be as small as possible. Among the commercialized glass tubes, one having a smallest diameter has at least 1 mm or so (Code No. 4360 available from Marienfeld of Deutschland).

Here, if the volume of 1 μL is measured using the aforementioned product,

$$\begin{matrix}L = \frac{4}{3.14 \times {0.1}^{2} {cm}^{2}} \times 1 \times {10}^{- 6} \times {10}^{3} {cm}^{3} \\ = 0.1274 cm \\ \approx 1.3 mm\end{matrix}$$

It can be found that the water is sucked at a length of about 1 mm. Taking into consideration that the least length of a linear scale used in general is 1 mm, it can be found that the least volume that can be measured by the capillary suction is about 1 μL. Thus, it can be found that, if the volume is less than 1 μL, the suction length is less than 1 mm, and thus the length L is hardly measured.

In other words, resolution of the volume measurement is about 1 μL, which means that only the volume of 1 μL or more can be visually measured.

However, high-performance glucose meters (available from Therasens of USA) that have recently been commercialized make it possible to make the blood glucose test with capillary blood of at least 0.3 μL. When the blood is collected from the alternative site using a vacuum lancing device, the blood volume of 1 μL or less is very frequently obtained. As such, for the purpose of performance evaluation and quality control of the vacuum lancing device and estimation of success probability of the blood glucose test for the alternative site, the blood volume of 1 μL or less must be accurately measured.

In contrast, the method based on the existing capillary suction principle can measure only the volume of 1 μL or more, and thus cannot be applied to the measurement of the blood volume of 1 μL or less. Accordingly, a method and a system capable of economically and easily measure the blood volume of 1 μL or less when the blood glucose test are required to be made for the alternative site.

### SUMMARY OF THE INVENTION

Accordingly, the present invention has been made keeping in mind the above problems occurring in the prior art, and embodiments of the present invention provide a

a method for accurately measuring a very small volume of blood, which is configured to collect the very small volume of blood using a lancing device intending for performance evaluation, to absorb the collected blood using an absorption medium, to dry the absorption medium, to scan the dried absorption medium using an image scanner connected to a computer to obtain a digital image, and to calculate the very small volume of blood from the digital image using an analysis program.

According to an embodiment of the present invention, there is provided a method for accurately measuring a very small volume of blood. The method comprises the steps of collecting the very small volume of blood using a lancing device intending for performance evaluation, absorbing the very small volume of collected blood into an absorption medium, drying the absorption medium, scanning the dried absorption medium using an image scanner connected to a computer to obtain a digital image, and calculating the very small volume of blood from the digital image using an analysis program.

Here, when the collected blood is absorbed using the absorption medium, the collected blood may be absorbed into the absorption medium, or by lightly contacting the absorption medium at a lanced site.

Further, the absorption medium may use a white one because it is advantageous for recognition of a color difference from the blood. The computer may include a personal computer.

Further, when the absorption medium is scanned by the image scanner, only a red component corresponding to the blood may be extracted. Only pixels having a size of the red component exceeding a predetermined threshold may be selected and counted. The counted value may be converted into an area according to a preset ratio. Further, the volume of blood may calculate an absorbed area of the absorption medium and use a calibration curve.

According to another embodiment of the present invention, there is provided a system for measuring a very small volume of blood. The system comprises: an absorption medium absorbing the blood collected; an image scanner converting the blood of the absorption medium into a digital image; and a computer connected to the image scanner and analyzing the digital image from the image scanner.

Here, the absorption medium may include a white absorption medium, and the computer may include a personal computer.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic view illustrating a capillary suction principle that measures a small volume of liquid;

FIG. 2 is a conceptual view illustrating a principle that converts a volume of blood into an absorbed area;

FIG. 3 is a conceptual view illustrating a digital image made up of pixels;

FIG. 4 is a schematic conceptual view illustrating a system for measuring a very small volume of blood; and

FIG. 5 is a graph showing the relationship between a counted value of colored pixels and a volume of blood contained in a micropipette.

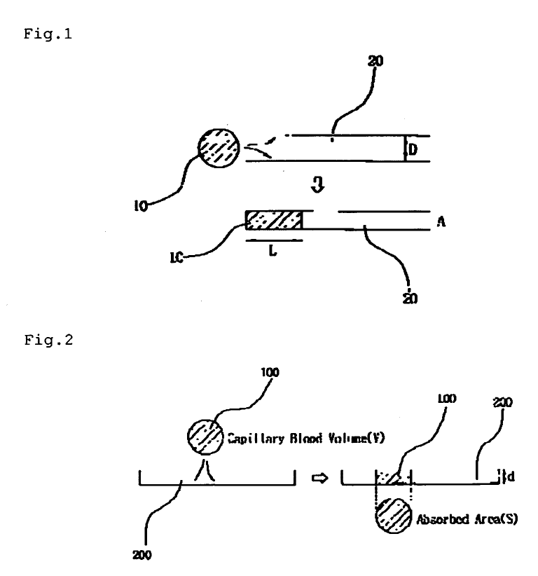

### DETAILED DESCRIPTION OF THE INVENTION

Hereinafter, an exemplary embodiment of the present invention will be described in detail with reference to the accompanying drawings.

According to an exemplary embodiment of the present invention, an absorption medium is used to easily measure a very small volume of blood. The absorption medium has a very high absorbability for liquid, particularly water. Thus, as illustrated in FIG. 2, when coming into contact with the absorption medium 200, the very small volume of blood 100, a main component of which is water, is absorbed while spreading in all directions. This absorption medium is frequently used as a disposable medium in order to absorb and remove a solution at a biochemical laboratory.

In FIG. 2, assuming that area S and thickness d of the absorption medium 200 absorbs the volume V of blood 100, the blood volume V is the product of area and thickness of the absorption medium 200, and is given as the following expression.

V=S·d

Solving it with respect to S, the following expression can be obtained.

$$S = \frac{V}{d}$$

The absorption medium 200 is similar to ordinary paper except the absorbability, and its thickness is very thin. Thus, although V is small in the expression above, V is divided by d that is still smaller than V. As a result, it is possible to obtain S having a relatively great value. In other words, when the very small volume V, which is difficult to directly measure, is absorbed into the thin adsorption medium 200 and then is converted into an area, the wide area S, which can be easily measured, can be obtained.

For example, when V=1 μL, and d=10 μm, the value of S is obtained from the following expression.

$$S = \frac{1 µ L}{10 µm} = \frac{1 \times {10}^{- 6} \times {10}^{3} {cm}^{3}}{10 \times {10}^{- 6} \times {10}^{2} {cm}^{2}} = 1 {cm}^{2} = 100 {mm}^{2}$$

Thus, it is possible to obtain the wide area S, which can be sufficiently measured with naked eyes.

As described above, after the very small volume of blood is absorbed into the absorption medium and then is converted into the relatively wide area, the absorbed area is accurately measured. Thereby, the volume of blood can be accurately measured.

Further, the absorption medium is generally white, and the blood is red. Accordingly, the absorption medium and the blood are significantly different from each other in terms of chromaticity. As such, the absorbed area can be definitely and visually discriminated. If the absorption medium into which the blood is absorbed is scanned by a typical scanner for the purpose of accurate and consistent area measurement, a digital image that can be easily analyzed through a computer can be obtained. In this case, the absorbed area can be accurately measured.

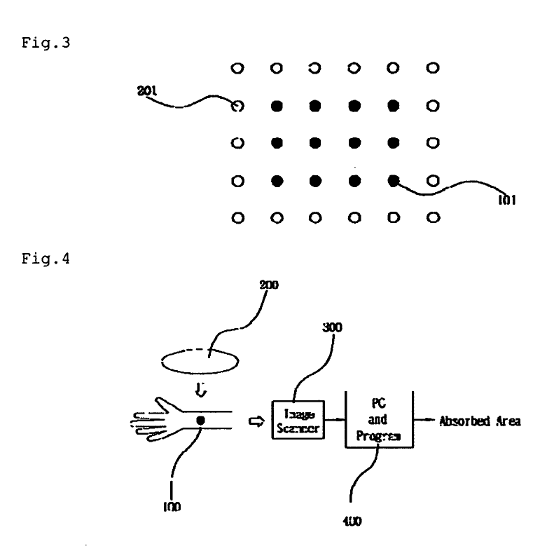

More specifically, since the digital image is a set of discontinuous pixels, the absorption medium into which the blood is absorbed are composed of pixels 101, which are colored by the blood, and the other pixels 201, which are not colored by the blood, when the image scanning the absorption medium into which the blood is absorbed is enlarged, as illustrated in FIG. 3. When only the colored pixels (blood) 101 are counted, the volume V proportional to the absorbed area S can be obtained. Here, in order to automatically recognize the colored pixels 101, only a red component is extracted from the image, and then only the pixels having the red component exceeding a predetermined threshold are counted. To this end, a commercialized program such as Photoshop or an independent program recently created can be used. Thus, when the image scanning the absorption medium is automatically analyzed using the computer program, the area of a region into which the blood is absorbed can be easily calculated. At this time, since the predetermined area of a computer image is made up of a predetermined number of pixels, the area of the absorption medium occupied by the colored pixels can be calculated when a factor, a ratio of the number of pixels to the area, is applied. Then, when the area of the absorption medium occupied by the colored pixels is multiplied by the thickness of the adsorption medium, the volume of absorbed blood can be finally measured.

FIG. 4 schematically illustrates a system for accurately measuring a very small volume of blood.

As an example, a very small volume of blood 100 is collected from an alternative site such as an arm using a lancing device intending for performance evaluation, and then a white absorption medium 200 is lightly contacted with the lanced site until it completely absorbs capillary blood, and is dried. The dried absorption medium 200 is scanned using an image scanner 300 connected to a personal computer 400. Thereby, a digital image is obtained, and then is analyzed with an analysis program operated by the computer 400. As a result, the volume of blood is calculated.

As described above, the system can be configured of an office scanner and a personal computer without a separate measuring or analyzing device, and the absorption medium employs very inexpensive disposable paper. Thus, the system makes it possible to accurately measure the very small volume of blood at a low cost.

### Embodiments

In order to check whether or not the above-mentioned method or system according to an embodiment of the present invention is effective, the following test was made.

First, a sufficient amount of venous blood was extracted from a normal person. Then, a predetermined volume of blood was injected into a micropipette (P10, Gilson, France), was dropped on an absorption medium, and thus was absorbed into the absorption medium. The absorption medium was dried.

Here, the predetermined volume of blood was injected in unit of 0.1 μL within a range from 0 μL to 1 μL, in unit of 0.2 μL within a range from 1 μL to 2 μL, and in unit of 1 μL within a range from 2 μL to 5 μL. With respect to each volume, five absorption media were obtained.

All the absorption media were scanned using a scanner, so that digital images were obtained. Then, the number of colored pixels of each digital image was counted using a program (Photoshop version 7.0), and thus is repeated five times with respect to the same volume of blood. Then, average value and standard deviation of the counted values repeated five times with respect to the same volume were calculated.

A linear or quadratic regression analysis was performed between the average value counting the number of colored pixels according to each volume and the blood volume of the micropipette, thereby yielding a calibration curve.

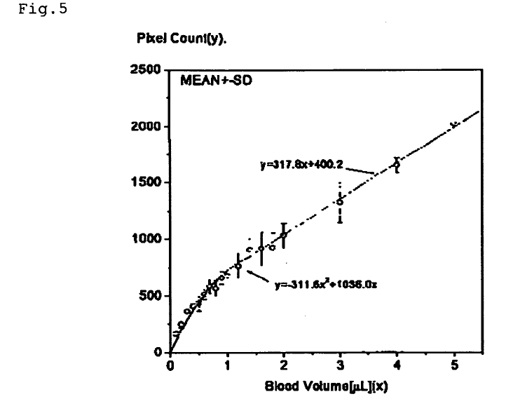

FIG. 5 is a graph showing relationship between a counted value of colored pixels and a volume of blood of a micropipette. The relationship between two variables was dependent on a quadratic function within a range from 0 μL to 1.5 μL, and a linear function within a range from 1.5 μL to 5 μL.

When a calibration curve of FIG. 5 was yielded, correlation was more than 0.99, which was very significant. It could be found that the standard deviation of the counted values repeated five times with respect to the predetermined volume of blood was very small, particularly below 1 μL, and thus that measurement having high consistency was performed. This meant that an accurate volume of blood was obtained by counting the number of colored pixels and then substituting the counted value into the calibration curve.

In other words, the volume of blood collected using the lancing device intended for evaluation could be accurately measured by substituting the calculated number of colored pixels into the calibration curve of FIG. 5.

As is apparent from the foregoing, the system capable of measuring a very small volume of blood using the white absorption medium and the scanner, which are easy available, and the personal computer and its count program. The very small volume of blood is absorbed into the absorption medium, and thus is converted into the wide area. Thereby, the converted area is calculated using the calibration curve, so that the very small volume of blood can be accurately measured. Thus, the performance evaluation as well as the quality control of the lancing device which is used by the diabetic patients can be easily carried out, and the very small volume of blood can be accurately measured.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for measuring a very small volume of blood, the method comprising the steps of:
collecting the very small volume of blood;
absorbing the very small volume of collected blood into an absorption medium;
drying the absorption medium;
scanning the dried absorption medium using an image scanner connected to a computer to obtain a digital image; and
calculating the very small volume of blood from the digital image using an analysis program.

2. The method as claimed in claim 1, wherein the absorption medium includes a white absorption medium.

3. The method as claimed in claim 1, wherein the computer includes a personal computer.

4. The method as claimed in claim 1, wherein the digital image extracts only a red component corresponding to the blood as an image.

5. A system for measuring a very small volume of blood, the system comprising:
an absorption medium absorbing the blood collected;
an image scanner converting the blood of the absorption medium into a digital image; and
a computer connected to the image scanner and analyzing the digital image from the image scanner.

6. The system as claimed in claim 5, wherein the absorption medium includes a white absorption medium, and the computer includes a personal computer.
